(19) United States
(12) Patent Application Publication
(10) Pub. No.: US 2026/0171047 A1
(43) Pub. Date: Jun. 18, 2026

(54) ELECTRONIC DEVICE COMPRISING PROXIMITY SENSOR ADAPTIVELY EMITTING FIRST LIGHT OR SECOND LIGHT

(71) Applicant: Samsung Electronics Co., Ltd., Suwon-si (KR)

(72) Inventors: Heeyoung JUNG, Suwon-si (KR); Hyunseok KIM, Suwon-si (KR); Hyojung LEE, Suwon-si (KR)

(21) Appl. No.: 19/410,500

(22) Filed: Dec. 5, 2025

Related U.S. Application Data
(63) Continuation of application No. PCT/KR2024/004988, filed on Apr. 12, 2024.

(30) Foreign Application Priority Data
Jun. 15, 2023 (KR) 10-2023-0076759
Aug. 1, 2023 (KR) 10-2023-0100727

(51) Int. Cl. G09G 5/12; H04M 1/72454

(52) U.S. Cl. CPC G09G 5/12; H04M 1/72454; G09G 2354/00; G09G 2360/141

(57) ABSTRACT

An electronic device is provided. The electronic device includes a processor. The electronic device includes a display including a display driving circuit and a display panel. The electronic device includes a proximity sensor positioned below an active area of the display panel.

### CROSS-REFERENCE TO RELATED APPLICATION(S)

This application is a continuation application, claiming priority under 35 U.S.C. § 365(c), of an International application No. PCT/KR 2024/004988, filed on Apr. 12, 2024, which is based on and claims the benefit of a Korean patent application number 10-2023-0076759, filed on Jun. 15, 2023, in the Korean Intellectual Property Office, and of a Korean patent application number 10-2023-0100727, filed on Aug. 1, 2023, in the Korean Intellectual Property Office, the disclosure of each of which is incorporated by reference herein in its entirety.

### BACKGROUND

### 1. Field

The disclosure relates to an electronic device comprising a proximity sensor that adaptively emits first light or second light.

### 2. Description of Related Art

An electronic device may comprise a proximity sensor. The proximity sensor may be configured to obtain data indicating whether an external object is adjacent to the electronic device. For example, the proximity sensor may be configured to emit light, receive reflection light of the light, and obtain the data based on the reflection light.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device comprising a proximity sensor that adaptively emits first light or second light.

Additional aspects will be set forth in part in the description which follows and, in part, will be apparent from the description, or may be learned by practice of the presented embodiments.

In accordance with an aspect of the disclosure, an electronic device is provided. The electronic device includes a processor. The electronic device includes a display including a display panel. The electronic device includes a proximity sensor positioned under an active area of the display panel. The processor is configured to obtain, from the proximity sensor, data indicating whether an external object is adjacent to the display panel while first light having a first wavelength or a second wavelength is emitted from the proximity sensor. The processor is configured to provide, to the display, an image to be displayed on the display panel, in response to the data obtained while the first light is emitted and indicating that an external object is not adjacent to the display panel. The proximity sensor is configured to emit second light having a second wavelength longer than the first wavelength to obtain the data within a time period in which the image is displayed on the display panel.

In accordance with another aspect of the disclosure, an electronic device is provided. The electronic device includes a processor. The electronic device includes a display including display driver circuitry and a display panel. The electronic device includes a proximity sensor positioned under an active area of the display panel. The proximity sensor is configured to emit first light having a first wavelength to obtain data indicating whether an external object is adjacent to the display panel while black color is provided through a portion of the active area over the proximity sensor. The proximity sensor is configured to obtain, from the display driver circuitry, a synchronization signal provided from the display driver circuitry to the processor to indicate a timing of providing an image to the display driver circuitry, while the first light is emitted. The proximity sensor is configured to, in response to the synchronization signal, emit second light having a second wavelength longer than the first wavelength to obtain the data.

In accordance with another aspect of the disclosure, an electronic device is provided. The electronic device includes a processor. The electronic device includes a display including display driver circuitry and a display panel. The electronic device includes a proximity sensor positioned under an active area of the display panel. The proximity sensor is configured to emit second light having a second wavelength to obtain data indicating whether an external object is adjacent to the display panel, based on obtaining, from the display driver circuitry, a synchronization signal provided from the display driver circuitry to the processor to indicate a timing of providing an image to the display driver circuitry. The proximity sensor is configured to identify whether additionally obtaining the synchronization signal is ceased for a reference time. The proximity sensor is configured to emit first light having a first wavelength shorter than the second wavelength to obtain the data, based on identifying that additionally obtaining the synchronization signal is ceased for the reference time.

In accordance with another aspect of the disclosure, an electronic device is provided. The electronic device includes a processor. The electronic device includes a display including a display panel. The electronic device includes a proximity sensor positioned under an active area of the display panel. The proximity sensor is configured to emit first light having a first wavelength to obtain data indicating whether an external object is adjacent to the display panel while black color is provided through a portion of the active area over the proximity sensor. The proximity sensor is configured to obtain, from the processor, a signal indicating that displaying an image on the display panel is started while the first light is emitted. The proximity sensor is configured to, in response to the signal, cease emitting the first light to obtain the data, and emit second light having a second wavelength longer than the first wavelength to obtain the data.

In accordance with another aspect of the disclosure, an electronic device is provided. The electronic device includes a display panel. The electronic device includes a proximity sensor, positioned under an active area of the display panel, including first transmission circuitry configured to emit first light having a first wavelength, second transmission circuitry configured to emit second light having a second wavelength longer than the first wavelength, and at least one reception circuitry configured to receive reflection light of the first light or the second light. The proximity sensor is configured to drive the first transmission circuitry, from among the first transmission circuitry and the second transmission circuitry, to obtain data indicating whether an external object is adjacent to the electronic device based on the reflection light, in accordance with a first state of the display panel. The proximity sensor is configured to drive the second transmission circuitry, from among the first transmission circuitry and the second transmission circuitry, to obtain the data based on the reflection light, in accordance with a second state of the display panel.

In accordance with another aspect of the disclosure, an electronic device is provided. The electronic device includes a display and a proximity sensor for sensing an external object, wherein the proximity sensor includes at least two light sources, positioned under an active area of the display, having different wavelengths, and at least one light-receiving circuitry configured to receive reflection light of the wavelengths, and wherein the at least two light sources are selectively driven in accordance with a state of the electronic device.

In accordance with another aspect of the disclosure, an electronic device is provided. The electronic device includes at least one processor including processing circuitry, a display including display driver circuitry and a display panel, and a proximity sensor positioned under an active area of the display panel, wherein the proximity sensor is configured to while a black color is provided through a portion of the active area over the proximity sensor, emit first light having a first wavelength to obtain data indicating whether an external object is adjacent to the display panel, wherein the first light is emitted while displaying an image on the display panel is deactivated, and is emitted while scanning of the display driver circuitry is ceased, obtain, from the display driver circuitry, a synchronization signal provided from the display driver circuitry to the at least one processor to indicate a timing for providing an image to the display driver circuitry, while the first light is emitted, and emit second light having a second wavelength longer than the first wavelength to obtain the data, in response to the synchronization signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electronic device including a proximity sensor positioned under an active area of a display panel according to an embodiment of the disclosure;

FIG. 2 illustrates a cross-sectional view cut along A-A′ of FIG. 1 according to an embodiment of the disclosure;

FIG. 3 illustrates an example of each of sub-pixels in an active area of a display panel of an electronic device according to an embodiment of the disclosure;

FIG. 4 is a simplified block diagram of an electronic device according to an embodiment of the disclosure;

FIG. 5 illustrates an example of signaling in an electronic device executed to change light emitted from a proximity sensor from first light to second light according to an embodiment of the disclosure;

FIG. 6 illustrates operations of a processor executed in accordance with data obtained from a proximity sensor while first light is emitted according to an embodiment of the disclosure;

FIG. 7 illustrates operations of a processor executed in accordance with data obtained from a proximity sensor while second light is emitted according to an embodiment of the disclosure;

FIG. 8 illustrates operations of a proximity sensor that ceases emitting first light and emits second light in response to a synchronization signal according to an embodiment of the disclosure;

FIG. 9 illustrates operations of a proximity sensor executed in accordance with data obtained while second light is emitted according to an embodiment of the disclosure;

FIG. 10 illustrates operations of a proximity sensor executed on a condition that obtaining a synchronization signal while the second light is emitted is ceased for a reference time according to an embodiment of the disclosure;

FIG. 11 illustrates operations of a proximity sensor executed to change light emitted from the proximity sensor from first light to second light in response to a signal from a processor according to an embodiment of the disclosure;

FIG. 12 illustrates operations of a proximity sensor executed to change light emitted from the proximity sensor from second light to first light in response to another signal from a processor according to an embodiment of the disclosure; and

FIG. 13 is a block diagram of an electronic device in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalent.

It is to be understood that the singular forms “a,” “an,” and “the” include plural referents unless the context clearly dictates otherwise. Thus, for example, reference to “a component surface” includes reference to one or more of such surfaces.

An electronic device may comprise a proximity sensor positioned under an active area of a display panel.

For example, the active area may indicate an area including sub-pixels usable for displaying an image on the display panel. For example, since the active area is an area usable (or available) for displaying an image, the active area may be referred to as a display area.

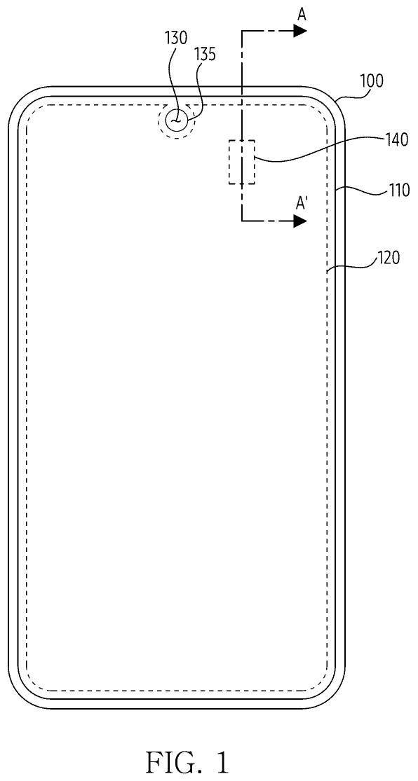

For example, the proximity sensor may be used to obtain data indicating whether an external object is adjacent to the electronic device (or the display panel). For example, the proximity sensor may be positioned under the active area (or the display area) to provide the wider active area (or the display area). The proximity sensor positioned under the active area may be exemplified in the description of FIG. 1.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 illustrates an electronic device including a proximity sensor positioned under an active area of a display panel according to an embodiment of the disclosure.

Referring to FIG. 1, an electronic device 100 may include a display panel 110. For example, the display panel 110 may include an active area 120 and a non-active area 130. For example, the non-active area 130 may be an area unusable (or unavailable) for displaying an image, unlike the active area 120. For example, the non-active area 130 may indicate an area not including sub-pixels configured to emit light for displaying an image. For example, the non-active area 130 may indicate an area including dead sub-pixels. For example, the non-active area 130 may be included in the display panel 110 for light to a camera 135 (e.g., a front camera 135 (or a selfie camera)) facing a direction corresponding to a direction toward which the display panel 110 faces. For example, the non-active area 130 may be aligned with the camera 135 positioned under the display panel 110. For example, the display panel 110 may further include another non-active area (not shown in FIG. 1) distinct from the non-active area 130. For example, the other non-active area may at least partially surround the active area 120.

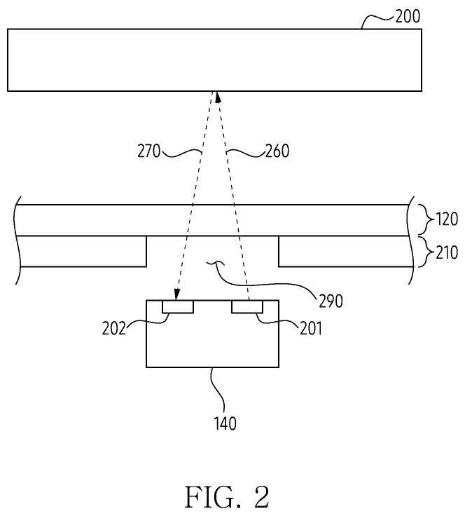

For example, a proximity sensor 140 in the electronic device 100 may be positioned under the active area 120. For example, the proximity sensor 140 under the active area 120 may emit, transmit, or radiate light to obtain the data. For example, the light may be infrared light (or infrared waves). For example, the light may be an infrared (IR) vertical cavity surface emitting laser (VCSEL). However, the disclosure is not limited thereto. For example, the proximity sensor 140 may emit the light to the outside through a portion of the active area 120 positioned over the proximity sensor 140, and may receive reflection light of the light. For example, the proximity sensor 140 may obtain the data indicating whether an external object is adjacent to the electronic device 100 (or the display panel 110) by including data on an amount of the reflection light. For example, the data may be obtained through an analog-to-digital converter (ADC) of the proximity sensor 140. An operation of the proximity sensor 140 emitting the light and an operation of the proximity sensor 140 obtaining the data may be exemplified in the description of FIG. 2.

FIG. 2 illustrates a cross-sectional view cut along A-A′ of FIG. 1 according to an embodiment of the disclosure.

Referring to FIG. 2, a proximity sensor 140 may be positioned under an active area 120 of a display panel 110. For example, the proximity sensor 140 may be disposed under a support member 210 (e.g., a metal plate) supporting the active area 120 (or the display panel 110). For example, the support member 210 may include an opening 290 (e.g., hole, slit, or slot) aligned with the proximity sensor 140. As a non-limiting example, the opening 290 being aligned with the proximity sensor 140 may indicate that the opening 290 includes the proximity sensor 140 when viewing the active area 120 in a second direction opposite to a first direction toward which the active area 120 faces. As a non-limiting example, the opening 290 being aligned with the proximity sensor 140 may indicate that the opening 290 overlaps the proximity sensor 140 when viewing the active area 120 in the second direction. As a non-limiting example, the opening 290 being aligned with the proximity sensor 140 may indicate that a direction of a virtual line extending from a center point of the opening 290 to a center of the proximity sensor 140 is the second direction. As a non-limiting example, the opening 290 being aligned with the proximity sensor 140 may indicate that light 260 from transmission circuitry 201 (or transmitter (or transmit unit, transmit part, transmission unit, transmission part, emitter, emitting unit, or emitting part)) of the proximity sensor 140 is emitted to the outside through the opening 290. As a non-limiting example, the opening 290 being aligned with the proximity sensor 140 may indicate that at least a portion of reflection light 270 of the light 260 is received (or delivered) through the opening 290 from the outside by reception circuitry 202 (or receiver (or receive unit, receive part, reception unit, reception part, light receiver, light receive unit, or light reception part)). As a non-limiting example, a size of the opening 290 may be larger than a size of the proximity sensor 140. As a non-limiting example, the size of the opening 290 may be identical to the size of the proximity sensor 140. As a non-limiting example, the size of the opening 290 may be smaller than the size of the proximity sensor 140.

For example, the proximity sensor 140 may emit the light 260 by using the transmission circuitry 201. For example, the light 260 may be emitted to the outside through the opening 290 and the active area 120. For example, the light 260 emitted to the outside may be reflected by an external object 200 around the electronic device 100 (or the display panel 110).

For example, the proximity sensor 140 may receive the reflection light 270 from the external object 200 by using the reception circuitry 202. For example, the proximity sensor 140 may obtain the data indicating whether the external object 200 is adjacent to the electronic device 100 (or the display panel 110), based on an amount of the reflection light 270.

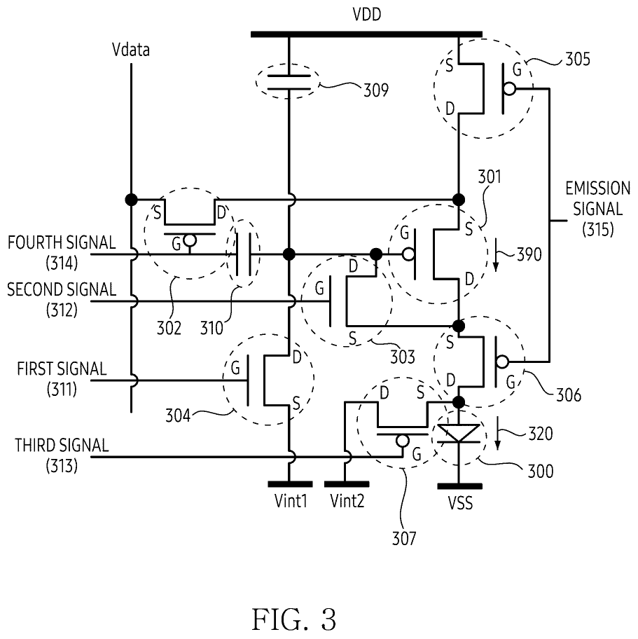

As in the above example, the light 260 passing through the active area 120 may at least partially affect sub-pixels within the active area 120. For example, each of the sub-pixels may include a driving transistor (e.g., a field effect transistor (FET)). For example, the light 260 passing through the active area 120 may cause a leakage current from a source (or a source terminal) of the driving transistor to a drain (or a drain terminal) of the driving transistor within a sub-pixel of the active area 120 positioned on (or positioned in) a path of the light 260, in accordance with a wavelength of the light 260. The leakage current may be exemplified in the description of FIG. 3.

FIG. 3 illustrates an example of each of sub-pixels in an active area of a display panel of an electronic device according to an embodiment of the disclosure.

Referring to FIG. 3, each of the sub-pixels may include a light-emitting element 300 (e.g., a light-emitting diode) (e.g., an organic light emitting diode (OLED)), a first transistor 301 (e.g., the driving transistor), a second transistor 302 (e.g., a switching transistor), a third transistor 303 (e.g., a compensation transistor), a fourth transistor 304 (e.g., an initialization transistor), a fifth transistor 305 (e.g., the operation control transistor), a sixth transistor 306 (e.g., the emission control transistor), a seventh transistor 307 (e.g., a bypass transistor), a capacitor 309 (e.g., a storage capacitor), and/or a capacitor 310 (e.g., a boost capacitor). Components within each of the sub-pixels illustrated in FIG. 3, their relationships, and their functions do not limit implementations described or claimed in the document.

For example, a gate of the first transistor 301 may be connected to a drain of the third transistor 303. For example, the gate of the first transistor 301 may be connected to a drain of the fourth transistor 304. For example, the gate of the first transistor 301 may be connected to a capacitor 309 used for storing a data voltage (Vdata). For example, the gate of the first transistor 301 may be connected to a capacitor 310 used for compensating a voltage drop caused by ceasing providing a fourth signal 314. For example, a source of the first transistor 301 may be connected to a drain of the second transistor 302. For example, the source of the first transistor 301 may be connected to a drain of the fifth transistor 305. For example, a drain of the first transistor 301 may be connected to a source of the third transistor 303. For example, the drain of the first transistor 301 may be connected to a source of the sixth transistor 306. For example, the first transistor 301 may be used to provide, to the light-emitting element 300, a current 320 in accordance with a data voltage (Vdata).

For example, a gate of the second transistor 302 may be configured to receive a fourth signal 314. For example, a source of the second transistor 302 may be configured to obtain a data voltage (Vdata).

For example, a gate of the third transistor 303 may be configured to receive a second signal 312.

For example, a gate of the fourth transistor 304 may be configured to receive a first signal 311. For example, a source of the fourth transistor 304 may be configured to obtain a first initialization voltage (Vint1) (e.g., about −3.5 (V)).

For example, a gate of the fifth transistor 305 may be configured to receive an emission signal 315. For example, a source of the fifth transistor 305 may be configured to obtain a first driving voltage (VDD).

For example, a gate of the sixth transistor 306 may be configured to receive the emission signal 315. For example, a drain of the sixth transistor 306 may be connected to a source of the seventh transistor 307. For example, the drain of the sixth transistor 306 may be connected to an anode of the light-emitting element 300.

For example, a gate of the seventh transistor 307 may be configured to receive a third signal 313. For example, a drain of the seventh transistor 307 may be configured to obtain a second initialization voltage (Vint2) (e.g., about −3 (V)).

For example, a cathode of the light-emitting element 300 may be configured to obtain a second driving voltage (VSS).

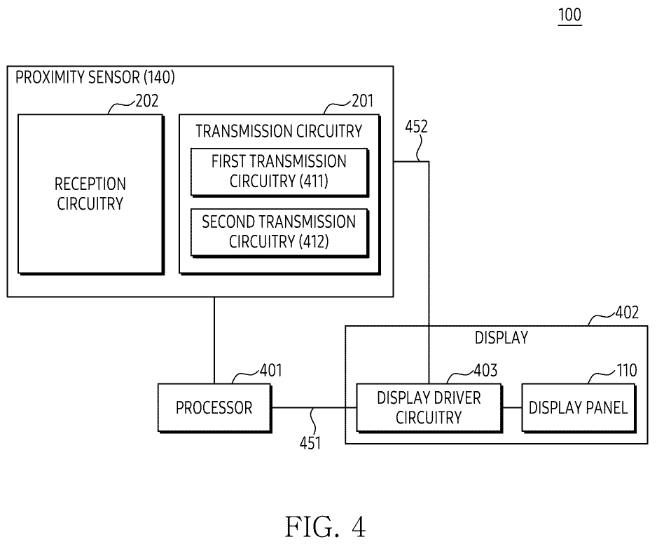

For example, display driver circuitry (e.g., display driver circuitry 403 of FIG. 4) may initialize the gate of the first transistor 301 by providing a first signal 311 to the gate of the fourth transistor 304.

For example, the display driver circuitry may initialize the anode of the light-emitting element 300 by providing a third signal 313 to the gate of the seventh transistor 307. For example, the anode may be initialized based on a second initialization voltage (Vint2). For example, the initialization of the anode may be executed to enhance representing black (or black color) by using the light-emitting element 300.

For example, the display driver circuitry may provide a data voltage (Vdata) to the gate of the first transistor 301 by providing a fourth signal 314 to each of the gate of the first transistor 301 and the gate of the second transistor 302. For example, providing a data voltage (Vdata) by providing the fourth signal 314 may be executed while the gate of the first transistor 301 is connected to the drain of the first transistor 301 through the third transistor 303 by providing the second signal 312 to the gate of the third transistor 303.

For example, the display driver circuitry may emit the light-emitting element 300 (e.g., light-emitting diode) for the displaying of the second image by providing, to the light-emitting diode 300, a current 320 in accordance with the data voltage (Vdata). For example, the display driver circuitry may provide the current 320 to the light-emitting element 300 to display an image on the active area 120 of the display panel 110 by providing an emission signal 315 to each of the gate of the fifth transistor 305 and the gate of the sixth transistor 306.

For example, the light 260 may cause shifting of a threshold voltage (or a turn-on voltage) of the first transistor 301, in accordance with a wavelength of the light 260. For example, the threshold voltage may indicate a minimum gate-to-source voltage (Vgs) of the first transistor 301 required to generate a conducting path between the source of the first transistor 301 and the drain of the first transistor 301. For example, the shifting of the threshold voltage may cause a leakage current 390 from the source of the first transistor 301 to the drain of the first transistor 301, and the leakage current 390 may cause a change in brightness provided from the light-emitting diode driven through the driving transistor. As a non-limiting example, the leakage current 390 may cause flickering (or photoelectric effect) within the active area 120. For example, the flickering may cause discomfort to a user.

For example, the electronic device 100 may include a proximity sensor 140, which is positioned under the active area 120 and is configured to emit first light having a first wavelength (e.g., about 940 nanometer (nm)) or second light having a second wavelength (e.g., about 1300 (nm)) longer than the first wavelength, to reduce occurrence of the flickering. For example, the electronic device 100 may reduce occurrence of the flickering by causing the proximity sensor 140 to adaptively emit the first light or the second light using at least one other component of the electronic device 100 distinguished from the proximity sensor 140. Components of the electronic device 100 for reducing occurrence of the flickering may be exemplified in the description of FIG. 4.

FIG. 4 is a simplified block diagram of an electronic device according to an embodiment of the disclosure.

Referring to FIG. 4, an electronic device 100 may include a processor 401, a display 402, and a proximity sensor 140.

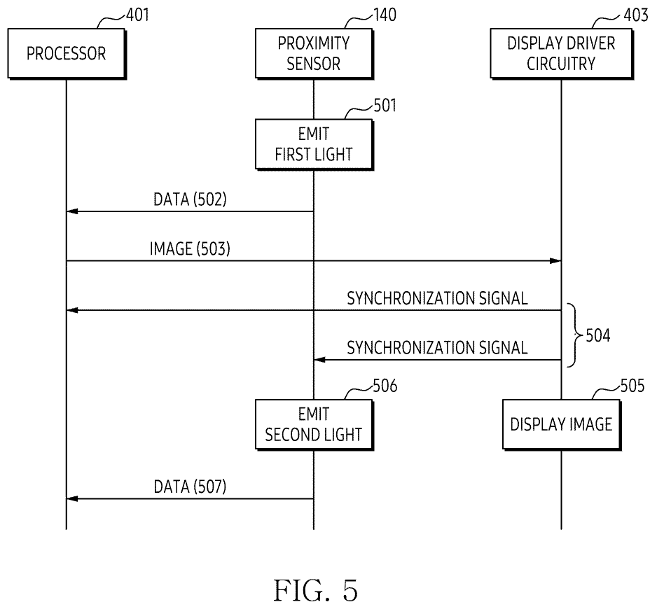

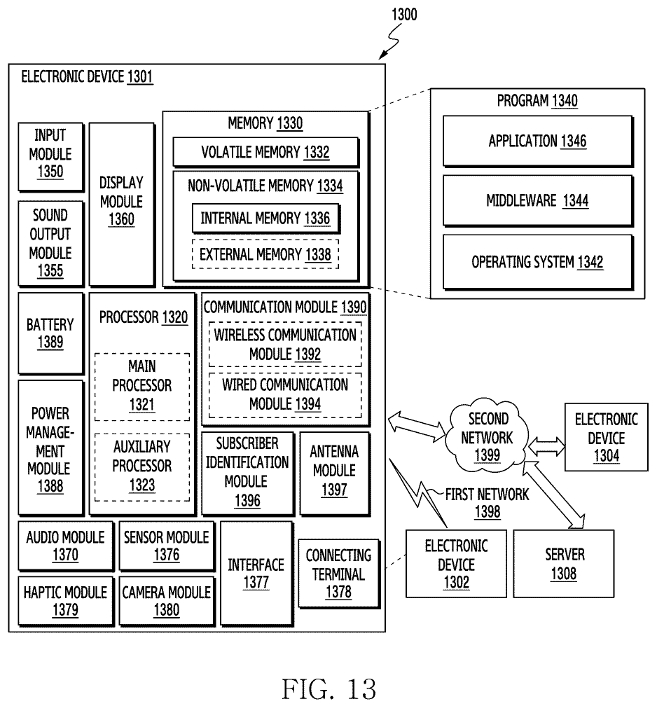

For example, the processor 401 (e.g., including processing circuitry) may include at least a portion of a processor 1320 of FIG. 13 or may at least partially correspond to the processor 1320 of FIG. 13. For example, the processor 401 may execute operations exemplified in descriptions of FIGS. 5 to 12 by executing instructions (at least temporarily) stored in memory (not shown in FIG. 4) (e.g., at least partially corresponding to the memory 1330 of FIG. 13) of the electronic device 100. For example, the instructions, when individually or collectively executed by the processor 401 (e.g., described as at least one processor), may cause the electronic device 100 to execute the operations exemplified in descriptions of FIGS. 5 to 12.

For example, the processor 401 may control the proximity sensor 140 or may cause the proximity sensor 140 to execute operations to be exemplified in descriptions of FIGS. 5 to 12. For example, the processor 401 may control the display driver circuitry 403 or may cause the display driver circuitry 403 to execute operations to be exemplified in descriptions of FIGS. 5 to 12. For example, the processor 401 may be connected to the proximity sensor 140 and may be connected to the display driver circuitry 403.

For example, the display 402 may include at least a portion of the display module 1360 of FIG. 13 or may at least partially correspond to the display module 1360 of FIG. 13. For example, the display 402 may include display driver circuitry 403 and a display panel 110. For example, the display driver circuitry 403 may be used to display an image on the active area 120 of the display panel 110.

As a non-limiting example, the display driver circuitry 403 may provide, to the processor 401, a synchronization signal (e.g., a tearing effect (TE) signal) to display an image received from the processor 401. For example, the synchronization signal may indicate a signal provided from the display driver circuitry 403 to the processor 401 to prevent the processor 401 from transmitting another image to the display driver circuitry 403 while the image is displayed. For example, the synchronization signal may indicate a signal provided from the display driver circuitry 403 to the processor 401 to inform the processor 401 of a timing of image transmission from the processor 401 to the display driver circuitry 403. For example, the synchronization signal may indicate a signal provided from the display driver circuitry 403 to the processor 401 before a start timing of a vertical synchronization signal used for displaying the image. For example, the synchronization signal being provided from the display driver circuitry 403 to the processor 401 may indicate that the display driver circuitry 403 will display the image on the display panel 110. As a non-limiting example, the synchronization signal may be provided from the display driver circuitry 403 to the processor 401 for a command mode of a display serial interface (DSI). As a non-limiting example, the synchronization signal may also be provided from the display driver circuitry 403 to the processor 401 for a video mode of the DSI.

For example, the electronic device 100 may include a path for the synchronization signal. For example, the path may include a first path 451 from the display driver circuitry 403 to the processor 401 (or a first path 451 between the processor 401 and the display driver circuitry 403) and a second path 452. For example, the first path 451 may be distinguished from a path for an image transmitted from the processor 401 to the display driver circuitry 403.

For example, the second path 452 may be used to provide the synchronization signal to the proximity sensor 140. For example, the synchronization signal may be provided from the display driver circuitry 403 to the proximity sensor 140 through the second path 452 for an adaptive operation of the proximity sensor 140.

FIG. 4 illustrates an example in which the second path 452 is completely separated from the first path 451. However, the second path 452 may be divided from the first path 451 and extend to the proximity sensor 140, unlike the illustration of FIG. 4.

For example, the proximity sensor 140 may include at least a portion of a sensor module 1376 of FIG. 13 or may at least partially correspond to the sensor module 1376 of FIG. 13. As a non-limiting example, the proximity sensor 140 may be used to identify illuminance around the electronic device 100. For example, the proximity sensor 140 may include transmission circuitry 201 and reception circuitry 202. For example, the transmission circuitry 201 may include first transmission circuitry 411 and second transmission circuitry 412. For example, the first transmission circuitry 411 may be configured to emit the first light having the first wavelength. For example, the second transmission circuitry 412 may be configured to emit the second light having the second wavelength. For example, at least a portion of the first transmission circuitry 411 may be referred to as a first light source, and at least a portion of the second transmission circuitry 412 may be referred to as a second light source. For example, the reception circuitry 202 may be configured to receive reflection light of the first light. The reception circuitry 202 may be referred to as light-receiving circuitry. For example, the reception circuitry 202 may be configured to receive reflection light of the second light. For example, the reception circuitry 202 may include photodiodes for receiving the reflection light of the first light and the reflection light of the second light. Although not illustrated in FIG. 4, the reception circuitry 202 may also include first reception circuitry for receiving the reflection light of the first light and second reception circuitry for receiving the reflection light of the second light.

The display 402 may include a first state in which the display 402 is activated and a second state in which the display 402 is deactivated.

As a non-limiting example, the first state may include a state in which the display 402 is turned on, and the second state may include a state in which the display 402 is turned off. As a non-limiting example, the first state may include a state in which the first path 451 is activated, and the second state may include a state in which the first path 451 is deactivated. For example, the first path 451 being deactivated may indicate that image transmission from the processor 401 to the display driver circuitry 403 is ceased. As a non-limiting example, the first state may include a state for performance, and the second state may include a state for lower power consumption. As a non-limiting example, the first state may include a state in which a change (or refresh) of an image displayed on the display panel 110 is activated, and the second state may include a state in which the change of the image displayed on the display panel 110 is deactivated. For example, the change of the image being deactivated may indicate that the image is maintained on the display panel 110. As a non-limiting example, the first state may include a state in which an image distinguished from a black image is provided on the display panel 110, and the second state may include a state in which the black image is provided on the display panel 110. As a non-limiting example, the first state may include a state in which a user input causing a change of an execution screen of a software application being executed in the electronic device 100 is received within a reference time period, and the second state may include a state in which the user input is not received within the reference time period. As a non-limiting example, the first state may include a state in which a power higher than a reference power is provided for driving the display 402, and the second state may include a state in which a power lower than or equal to the reference power is provided for driving the display 402. For example, the reference power may be 0 (W). As a non-limiting example, the first state may include a state in which an image is displayed on the display panel 110 with a brightness level higher than a reference brightness level, and the second state may include a state in which an image is displayed on the display panel 110 with a brightness level lower than or equal to the reference brightness level.

For example, the processor 401, the display driver circuitry 403, and the proximity sensor 140 may execute operations for reducing the leakage current or reducing occurrence of the flickering. For example, the operations may include an operation of changing light emitted from the proximity sensor 140 from the first light to the second light and an operation of identifying a condition for changing the light from the first light to the second light. The operations may be exemplified in the description of FIG. 5.

FIG. 5 illustrates an example of signaling in an electronic device executed to change light emitted from a proximity sensor from first light to second light according to an embodiment of the disclosure.

Referring to FIG. 5, in operation 501, the proximity sensor 140 may emit the first light to obtain the data indicating whether an external object (e.g., an external object 200) is adjacent to the electronic device 100 (or the display panel 110).

As a non-limiting example, the first light may be emitted while displaying of an image on the display panel 110 is deactivated. For example, the first light may be emitted while a black color is provided through a portion of the active area 120 over the proximity sensor 140. For example, the first light may be emitted while scanning of the display driver circuitry 403 executed for displaying an image on the display panel 110 is ceased. For example, the first light may be emitted while image transmission from the processor 401 to the display driver circuitry 403 is ceased.

For example, the first light may cause a leakage current from a source of a driving transistor (e.g., the first transistor 301) to a drain of the driving transistor in a sub-pixel of the active area 120. For example, the leakage current may cause occurrence of flickering within the active area 120. For example, the proximity sensor 140 may emit the first light while an image is not displayed on the active area 120 to reduce occurrence of the flickering. As a non-limiting example, the first light may be periodically emitted according to a first duty ratio.

As a non-limiting example, the first light may be emitted while a black color is provided within a portion of the active area 120 positioned over the proximity sensor 140. For example, the electronic device 100 may support a mode (e.g., an always on display (AOD) mode) for displaying an image while the processor 401 is in a sleep state or a low-power state. For example, the processor 401 may provide a signal (or a flag signal) indicating that the AOD mode is activated to the proximity sensor 140 before activation of the mode starts. For example, the proximity sensor 140 may emit the first light based on the signal. For example, an image displayed in the AOD mode may have a black color in a partial area corresponding to the portion. For example, since the partial area of the image displayed in the AOD mode has the black color, the proximity sensor 140 may emit the first light even though the image is displayed in the AOD mode. However, the disclosure is not limited thereto.

As a non-limiting example, a portion of the active area 120 in which the electronic device 100 identifies a color to determine a wavelength of light of the proximity sensor 140 may be associated with a portion of the active area 120 positioned over the proximity sensor 140. For example, in a case that a color of a portion having a size larger than the portion positioned over the proximity sensor 140 corresponds to a black color, the proximity sensor 140 may emit first light. For example, a wavelength of light emitted through the proximity sensor 140 may be changed based on a color of a portion of the active area 120 in which flickering caused by the first light emitted from the proximity sensor 140 occurs. For example, a portion of the active area 120 in which a color is identified to determine a wavelength of light of the proximity sensor 140 may be determined based on a size, a position, and/or a shape of a portion of the active area 120 that flickers by a photoelectric effect while the first light is emitted.

In operation 502, the proximity sensor 140 may provide, to the processor 401, the data obtained while the first light is emitted. In the example of FIG. 5, the data may indicate that an external object is not adjacent to the electronic device 100 (or the display panel 110). For example, the data indicating that an external object is not adjacent to the electronic device 100 may indicate an amount of reflection light of the first light being less than a reference amount of light. For example, the data may be obtained through the proximity sensor 140 in a case that the external object is spaced apart from the electronic device 100 (or the display panel 110) by a distance longer than a certain distance.

For example, the processor 401 may obtain the data from the proximity sensor 140.

In operation 503, the processor 401 may provide, to the display driver circuitry 403, an image to be displayed on the display panel 110 in response to the data indicating that an external object is not adjacent to the electronic device 100 (or the display panel 110). As a non-limiting example, the processor 401 may provide the image to the display driver circuitry 403 for the command mode. As a non-limiting example, the processor 401 may provide the image to the display driver circuitry 403 for the video mode. As a non-limiting example, the image may be an image available for a call with a user of an external electronic device. For example, the image may include a user interface of a software application for a call.

For example, the display driver circuitry 403 may obtain the image from the processor 401.

Although not illustrated in FIG. 5, as a non-limiting example, the processor 401 may provide, to the display driver circuitry 403, a command indicating that providing the image is started before providing the image to the display driver circuitry 403.

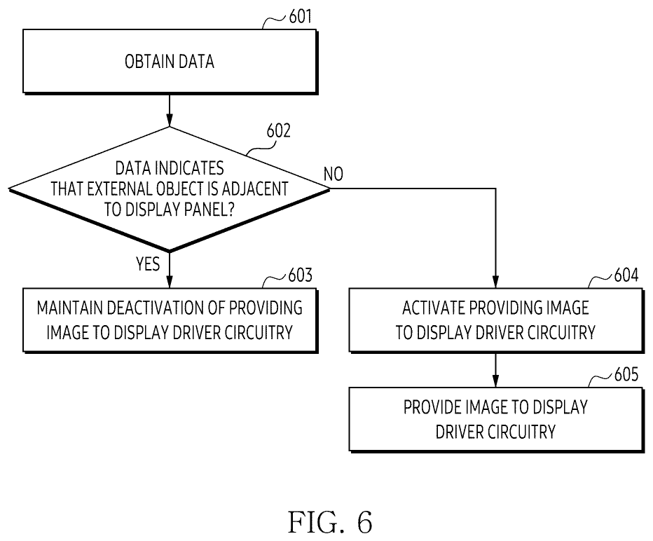

Although not illustrated in FIG. 5, the processor 401 may refrain from transmission of the image to the display driver circuitry 403, in response to the data obtained while the first light is emitted and indicating that an external object is adjacent to the electronic device 100 (or the display panel 110). Refraining from the transmission of the image to the display driver circuitry 403 will be exemplified in the description of FIG. 6.

In operation 504, the display driver circuitry 403 may provide the synchronization signal to the processor 401 and/or the proximity sensor 140 before displaying the image on the display panel 110, in response to the command and/or the image.

For example, the synchronization signal may be provided from the display driver circuitry 403 to the processor 401 to prevent the processor 401 from providing another image to the display driver circuitry 403 while the image is displayed on the display panel 110 (or the active area 120) by the display driver circuitry 403. For example, the processor 401 may obtain the synchronization signal from the display driver circuitry 403.

For example, the synchronization signal may be provided from the display driver circuitry 403 to the proximity sensor 140 to cease emitting the first light as in operation 501 and emit the second light while the image is displayed on the active area 120. For example, since the second wavelength of the second light is longer than the first wavelength of the first light, the second light may reduce occurrence of the leakage current unlike the first light. For example, the synchronization signal may be provided from the display driver circuitry 403 to the proximity sensor 140 to reduce occurrence of the flickering in accordance with the leakage current while the image is displayed on the active area 120. For example, the proximity sensor 140 may obtain the synchronization signal from the display driver circuitry 403.

For example, the synchronization signal may be provided to the processor 401 through a first path 451. For example, the synchronization signal may be provided to the proximity sensor 140 through a second path 452.

In operation 505, the display driver circuitry 403 may display the image obtained in operation 503 on the display panel 110 (or the active area 120). For example, the image may be displayed based on a vertical synchronization signal that starts after the synchronization signal is provided to the processor 401 and/or the proximity sensor 140.

In operation 506, the proximity sensor 140 may emit the second light to obtain the data within a time period in which the image is displayed on the active area 120 (or the display panel 110), in response to the synchronization signal. As a non-limiting example, the second light may be periodically emitted according to a second duty ratio. For example, the second duty ratio may be greater than the first duty ratio.

For example, the proximity sensor 140 may cease emitting the first light and may emit the second light, in response to the synchronization signal. For example, the proximity sensor 140 may change light emitted from the proximity sensor 140 from the first light to the second light, in response to the synchronization signal. For example, since a probability that the flickering is caused by the second light is lower than a probability that the flickering is caused by the first light, the electronic device 100 may enhance a quality of an image displayed on the display panel 110 through the change from the first light to the second light.

For example, since the second light may reduce occurrence of the flickering compared to the first light, use of a method of emitting only the second light among the first light and the second light may be considered. However, since a second current provided to the proximity sensor 140 for emitting the second light from the proximity sensor 140 is higher than a first current provided to the proximity sensor 140 for emitting the first light from the proximity sensor 140, and the duty ratio used for emitting the second light from the proximity sensor 140 is greater than the duty ratio used for emitting the first light from the proximity sensor 140, power consumed by emitting the second light may be greater than power consumed by emitting the first light. For example, in order to reduce power consumed by the proximity sensor 140, the electronic device 100 may emit the first light from the proximity sensor 140 within at least a portion of a time period in which an image is not displayed on the display panel 110 (or the active area 120), and emit the second light from the proximity sensor 140 within a time period in which an image is displayed on the display panel 110 (or the active area 120).

In operation 507, the proximity sensor 140 may provide, to the processor 401, the data obtained while the second light is emitted. For example, the processor 401 may obtain the data from the proximity sensor 140.

Periodically emitting the second light based on the second duty ratio may include changing periodically emitting the second light based on the first duty ratio to periodically emitting the second light based on the second duty ratio. For example, the proximity sensor 140 may periodically emit the second light based on the first duty ratio. For example, the proximity sensor 140 may provide, to the processor 401, the data obtained while the second light is periodically emitted based on the first duty ratio. For example, the processor 401 may control or cause the proximity sensor 140 to change the first duty ratio to the second duty ratio, in response to identifying that the data indicates that an external object is adjacent to the electronic device 100 (or the display panel 110). For example, the proximity sensor 140 may change periodically emitting the second light based on the first duty ratio to periodically emitting the second light based on the second duty ratio, in response to the control of the processor 401.

Providing the second current to the proximity sensor 140 for emitting the second light may include changing providing the first current to the proximity sensor 140 for emitting the second light to providing the second current to the proximity sensor 140 for emitting the second light. For example, the processor 401 may provide, to the proximity sensor 140, the first current to emit the second light. For example, the proximity sensor 140 may provide, to the processor 401, the data obtained while the second light is emitted based on the first current. For example, the processor 401 may change the first current provided to the proximity sensor 140 to the second current, in response to identifying that the data indicates that an external object is adjacent to the electronic device 100 (or the display panel 110).

As described above, FIG. 5 illustrates an operation when the data obtained while the first light is emitted indicates that an external object is not adjacent to the electronic device 100 (or the display panel 110). An operation when the data obtained while the first light is emitted indicates that an external object is adjacent to the electronic device 100 (or the display panel 110) may be exemplified in the description of FIG. 6.

FIG. 6 illustrates operations of a processor executed in accordance with data obtained from a proximity sensor while first light is emitted according to an embodiment of the disclosure.

Referring to FIG. 6, in operation 601, the processor 401 may obtain, from the proximity sensor 140, the data obtained while the first light is emitted. For example, operation 601 may correspond to operation 502.

In operation 602, the processor 401 may identify, determine, or check whether the data obtained in operation 601 indicates that an external object is adjacent to the display panel 110 (or the active area 120). For example, the processor 401 may execute operation 602 through a comparison between the reference amount of light and an amount of light indicated by the data. For example, the processor 401 may execute operation 603 in response to the data indicating that an external object is adjacent to the display panel 110, and may execute operation 604 in response to the data indicating that an external object is not adjacent to the display panel 110.

In operation 603, the processor 401 may maintain a deactivation of providing an image to the display driver circuitry 403, on a condition that the data indicates an external object is adjacent to the display panel 110. For example, the processor 401 may refrain from providing the image to the display driver circuitry 403 even when an image generated or obtained by the processor 401 exists. For example, since an external object being adjacent to the display panel 110 may indicate that a user of the electronic device 100 brings the electronic device 100 into contact with the user's ear for a call with a user of an external electronic device, the processor 401 may refrain from providing the image. Although not shown in FIG. 6, since providing an image from the processor 401 to the display driver circuitry 403 is deactivated, the proximity sensor 140 may maintain emitting the first light. However, the disclosure is not limited thereto.

In operation 604, the processor 401 may activate providing an image to the display driver circuitry 403, on a condition that the data indicates an external object is not adjacent to the display panel 110. For example, it should be noted that the activation merely indicates that a state of the processor 401 is a state capable of providing an image to the display driver circuitry 403, and does not indicate that a transmission of an image from the processor 401 to the display driver circuitry 403 is necessarily executed.

In operation 605, the processor 401 may provide, to the display driver circuitry 403, an image generated or obtained by the processor 401 after the activation. For example, operation 605 may correspond to operation 503.

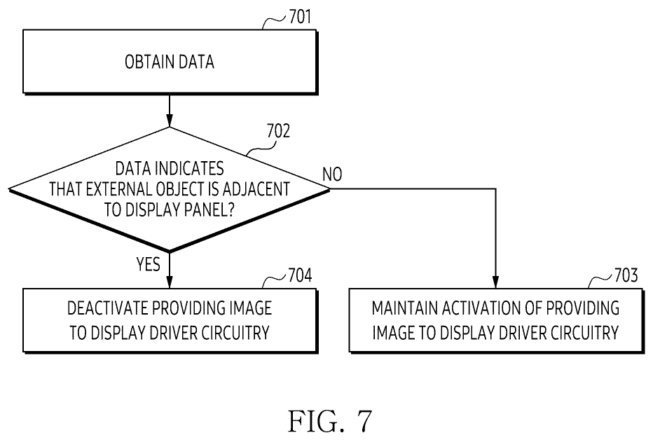

For example, operations associated with the data obtained while the second light is emitted may be at least partially different from operations associated with the data obtained while the first light is emitted (e.g., the operations of FIG. 6). The operations associated with the data obtained while the second light is emitted may be exemplified in the description of FIG. 7.

FIG. 7 illustrates operations of a processor executed in accordance with data obtained from a proximity sensor while second light is emitted according to an embodiment of the disclosure.

Referring to FIG. 7, in operation 701, the processor 401 may obtain, from the proximity sensor 140, the data obtained while the second light is emitted. For example, operation 701 may correspond to operation 507.

In operation 702, the processor 401 may identify, determine, or check whether the data obtained in operation 701 indicates that an external object is adjacent to the display panel 110 (or the active area 120). For example, the processor 401 may execute operation 702 through a comparison between a reference amount of light and an amount of light indicated by the data. For example, the reference amount of light may be the same as or different from the reference amount of light used in operation 602 of FIG. 6. For example, the processor 401 may execute operation 703 in response to the data indicating that an external object is not adjacent to the display panel 110, and may execute operation 704 in response to the data indicating that an external object is adjacent to the display panel 110.

In operation 703, the processor 401 may maintain an activation of providing an image to the display driver circuitry 403 on a condition that the data indicates that an external object is not adjacent to the display panel 110. For example, the processor 401 may provide, to the display driver circuitry 403, an image obtained by the processor 401 based on a synchronization signal obtained from the display driver circuitry 403, in response to the data indicating that an external object is not adjacent to the display panel 110.

In operation 704, the processor 401 may deactivate providing an image to the display driver circuitry 403 on a condition that the data indicates that an external object is adjacent to the display panel 110. For example, the processor 401 may refrain from providing the image to the display driver circuitry 403, even when an image generated or obtained by the processor 401 exists. For example, since an external object being adjacent to the display panel 110 may indicate that a user of the electronic device 100 brings the electronic device 100 into contact with an ear for a call with a user of an external electronic device, the processor 401 may refrain from providing the image.

Although not illustrated in FIG. 7, since providing an image from the processor 401 to the display driver circuitry 403 is deactivated, the display driver circuitry 403 may cease providing the synchronization signal to the processor 401 on a condition that an image to be displayed on the display panel 110 does not exist. For example, the proximity sensor 140 may emit the first light to obtain the data, based on the cessation of providing the synchronization signal. For example, the proximity sensor 140 may cease emitting the second light to obtain the data, based on the cessation of providing the synchronization signal.

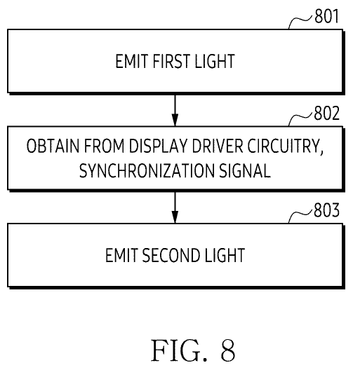

The operations of the proximity sensor 140 described in the description of FIG. 5 may also be exemplified as in the description of FIG. 8.

FIG. 8 illustrates operations of a proximity sensor that ceases emitting first light and emits second light in response to a synchronization signal according to an embodiment of the disclosure.

Referring to FIG. 8, in operation 801, the proximity sensor 140 may emit the first light to obtain the data indicating whether an external object is adjacent to the display panel 110. For example, the proximity sensor 140 may emit the first light while the synchronization signal is not obtained from the display driver circuitry 403. For example, operation 801 may correspond to operation 501.

In operation 802, the proximity sensor 140 may obtain, from the display driver circuitry 403 while the first light is emitted, the synchronization signal provided from the display driver circuitry 403 to the processor 401 to indicate a timing of providing an image to the display driver circuitry 403. For example, the synchronization signal may be provided to the proximity sensor 140 from the display driver circuitry 403 through a second path 452. For example, operation 802 may correspond to operation 504.

In operation 803, the proximity sensor 140 may emit the second light to obtain the data in response to the synchronization signal. As a non-limiting example, the second light may be emitted based on a second current higher than a first current provided to the proximity sensor 140 for emitting the first light, by using a duty ratio greater than a duty ratio used for emitting the first light. For example, the proximity sensor 140 may cease emitting the first light, in response to the synchronization signal.

For example, since the synchronization signal is provided to the processor 401 before an image is displayed on the display panel 110, the electronic device 100 may refrain from emitting the first light and emit the second light within a time period in which the image is displayed, thereby reducing occurrence of flickering in the active area 120 due to emitting the first light.

For example, operation 803 may correspond to operation 506.

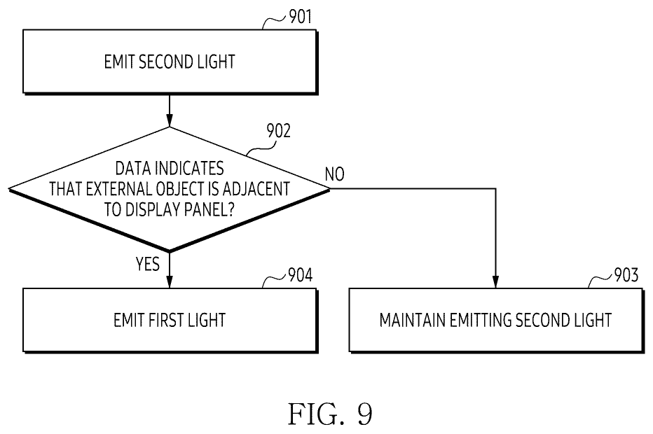

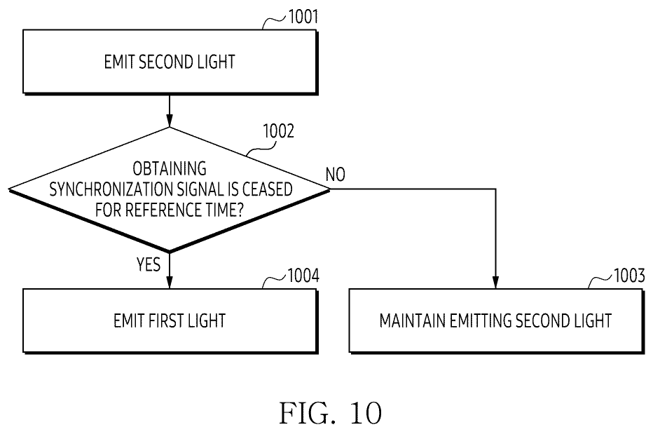

For example, since a power consumed by emitting the second light is greater than a power consumed by emitting the first light, the proximity sensor 140 may identify, check, or recognize whether operations for ceasing displaying an image on the display panel 110 (or the active area 120) are executed while the second light is emitted. For example, the identifying, the checking, or the recognizing may be executed for a timing to cease emitting the second light and to emit the first light. The identifying, the checking, or the recognizing may be exemplified in the descriptions of FIGS. 9 and 10.

FIG. 9 illustrates operations of a proximity sensor executed in accordance with data obtained while second light is emitted according to an embodiment of the disclosure.

Referring to FIG. 9, in operation 901, the proximity sensor 140 may emit the second light to obtain the data. For example, operation 901 may correspond to operation 803.

In operation 902, the proximity sensor 140 may identify, check, or determine whether the data obtained while the second light is emitted indicates that an external object is adjacent to the display panel 110. For example, the proximity sensor 140 may execute operation 902 through a comparison between an amount of reflection light of the second light and a reference amount of light. As a non-limiting example, the reference amount of light used in operation 902 may be substantially the same as the reference amount of light exemplified for the description of operation 702.

For example, the comparison may be executed by the proximity sensor 140. For example, the comparison may also be executed by the processor 401 based on the data obtained from the proximity sensor 140. However, the disclosure is not limited thereto.

For example, the proximity sensor 140 may execute operation 903 when the data indicates that an external object is not adjacent to the display panel 110, and may execute operation 904 when the data indicates that an external object is adjacent to the display panel 110.

In operation 903, the proximity sensor 140 may maintain emitting the second light, on a condition that the data indicates an external object is not adjacent to the display panel 110. For example, since a state in which an external object is not adjacent to the display panel 110 may indicate a state in which an image may be displayed on the display panel 110, the proximity sensor 140 may maintain emitting the second light in response to the data indicating that an external object is not adjacent to the display panel 110.

For example, when the comparison exemplified in operation 902 is executed by the processor 401, the proximity sensor 140 may maintain emitting the second light based on receiving, from the processor 401, a signal indicating maintaining emitting the second light. For example, when the comparison exemplified in operation 902 is executed by the processor 401, the proximity sensor 140 may maintain emitting the second light based on identifying or confirming that another signal indicating emitting the first light or ceasing emitting of the second light is not received from the processor 401. However, the disclosure is not limited thereto.

In operation 904, the proximity sensor 140 may emit the first light on a condition that the data indicates an external object is adjacent to the display panel 110. For example, since a state in which an external object is adjacent to the display panel 110 may indicate a state in which an image is not displayed on the display panel 110, the proximity sensor 140 may emit the first light in response to the data indicating that an external object is adjacent to the display panel 110. For example, the proximity sensor 140 may cease emitting the second light on a condition that the data indicates an external object is adjacent to the display panel 110. For example, the proximity sensor 140 may emit the first light and may cease emitting the second light to reduce a power consumed by the proximity sensor 140.

For example, when the comparison exemplified in operation 902 is executed by the processor 401, the proximity sensor 140 may emit the first light and may cease emitting the second light, based on identifying or confirming that the another signal is received from the processor 401.

As described above, the electronic device 100 may reduce power consumption associated with use of the proximity sensor 140 by identifying, based on the data obtained through the proximity sensor 140, whether an image is in a state capable of being displayed on the display panel 110.

FIG. 10 illustrates operations of a proximity sensor executed on a condition that obtaining a synchronization signal while the second light is emitted is ceased for a reference time according to an embodiment of the disclosure.

Referring to FIG. 10, in operation 1001, the proximity sensor 140 may emit the second light to obtain the data. For example, operation 1001 may correspond to operation 803.

In operation 1002, the proximity sensor 140 may identify, check, or determine whether obtaining the synchronization signal is ceased for a reference time. For example, the proximity sensor 140 may identify whether obtaining the synchronization signal is ceased for a reference time, by identifying whether the synchronization signal is newly (or additionally) obtained from the display driver circuitry 403 for the reference time from a timing at which the synchronization signal was most recently obtained from the display driver circuitry 403. For example, the reference time may be set to a time capable of being recognized as a time at which the display driver circuitry 403 ceases displaying an image on the display panel 110 (or the active area 120). As a non-limiting example, the reference time may correspond to a minimum refresh rate among a plurality of refresh rates supported by the display driver circuitry 403. As a non-limiting example, the reference time may be 1 (second).

For example, the proximity sensor 140 may execute operation 1003 on a condition that obtaining the synchronization signal is not ceased for the reference time, and may execute operation 1004 on a condition that obtaining the synchronization signal is ceased for the reference time.

In operation 1003, the proximity sensor 140 may maintain emitting the second light while obtaining the synchronization signal is not ceased for the reference time.

In operation 1004, the proximity sensor 140 may emit the first light in response to identifying that obtaining the synchronization signal is ceased for the reference time. For example, the proximity sensor 140 may cease emitting the second light in response to identifying that obtaining the synchronization signal is ceased for the reference time. For example, the proximity sensor 140 may emit the first light and may cease emitting the second light to reduce a power consumed by the proximity sensor 140.

As described above, the electronic device 100 may reduce power consumption in accordance with use of the proximity sensor 140, by identifying, based on the synchronization signal from the display driver circuitry 403, whether an image is in a state capable of being displayed on the display panel 110.

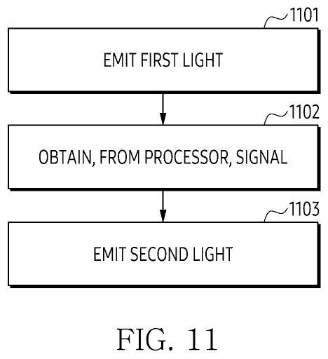

The above descriptions illustrate an example in which a condition for changing light emitted from the proximity sensor 140 from the first light to the second light is identified based on the synchronization signal from the display driver circuitry 403. However, identifying the condition based on the synchronization signal from the display driver circuitry 403 may be replaced with identifying the condition based on a signal from the processor 401. Identifying the condition based on a signal from the processor 401 may be exemplified in the description of FIG. 11.

FIG. 11 illustrates operations of a proximity sensor executed to change light emitted from the proximity sensor from first light to second light in response to a signal from a processor according to an embodiment of the disclosure.

Referring to FIG. 11, in operation 1101, the proximity sensor 140 may emit the first light to obtain data indicating whether an external object is adjacent to the display panel 110. For example, the proximity sensor 140 may emit the first light while an image is not displayed on the display panel 110.

In operation 1102, the proximity sensor 140 may obtain, from the processor 401, a signal indicating a start of displaying an image on the display panel 110 while the first light is emitted. For example, the signal may be provided to the proximity sensor 140 before starting of displaying an image on the display panel 110. For example, the signal obtained in operation 1102 may be provided to the proximity sensor 140 based on the processor 401 providing a vertical sync start (VSS) packet to the display driver circuitry 403. For example, since the VSS packet is a packet provided to the display driver circuitry 403 before providing an image to the display driver circuitry 403, the signal provided based on the VSS packet may be used to control the light from the proximity sensor 140 before an image is displayed on the display panel 110.

In operation 1103, in response to the signal, the proximity sensor 140 may emit the second light to obtain the data and may cease emitting the first light to obtain the data. For example, emitting the second light may be maintained until another signal to be exemplified below is obtained.

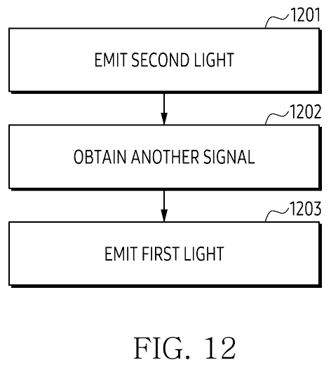

For example, the proximity sensor 140 may identify whether the another signal indicating a termination of displaying an image on the display panel 110 is obtained from the processor 401 while the second light is emitted. For example, in response to the another signal obtained from the processor 401, the proximity sensor 140 may cease emitting the second light and may emit the first light. Such operations may be illustrated in the description of FIG. 12.

FIG. 12 illustrates operations of a proximity sensor executed to change light emitted from the proximity sensor from second light to first light in response to another signal from a processor according to an embodiment of the disclosure.

Referring to FIG. 12, in operation 1201, the proximity sensor 140 may emit the second light. For example, operation 1201 may correspond to operation 1103.

In operation 1202, the proximity sensor 140 may obtain, from the processor 401, the another signal indicating a termination of displaying an image on the display panel 110 while the second light is emitted. For example, the another signal may be provided after displaying a last image on the display panel 110 is completed based on information on a refresh rate provided, from the processor 401, to the display driver circuitry 403.

In operation 1203, the proximity sensor 140 may emit the first light and may cease emitting the second light, in response to the another signal. For example, emitting the first light may be maintained until the signal exemplified in the description of FIG. 11 is obtained.

Unlike those exemplified in the descriptions of FIGS. 11 and 12, as a non-limiting example, the first light may be emitted while an image is displayed on the display panel 110. For example, the processor 401 may obtain an image to be displayed on the display panel 110 and may identify a color of a partial area of the image corresponding to a portion of the active area 120 over the proximity sensor 140. For example, based on identifying that the color is a black color, the processor 401 may control the proximity sensor 140 to emit the first light even though the image is displayed on the display panel 110. For example, based on identifying that the color is a color distinguished from the black color, the processor 401 may control the proximity sensor 140 to emit the second light.

As another example, the processor 401 may identify a refresh rate for displaying on the display panel 110. For example, the processor 401 may control the proximity sensor 140 to emit the first light, based on the refresh rate being lower than a reference refresh rate. For example, since an image displayed based on the refresh rate lower than the reference refresh rate may be set in the electronic device 100 to have a black color within a partial area corresponding to the portion, the processor 401 may control the proximity sensor 140 to emit the first light. For example, the processor 401 may control the proximity sensor 140 to emit the second light, based on the refresh rate being higher than or equal to the reference refresh rate.

The operations exemplified through the above descriptions may be executed in an electronic device exemplified below.

FIG. 13 is a block diagram illustrating an electronic device 1301 in a network environment 1300 according to an embodiment of the disclosure.

Referring to FIG. 13, the electronic device 1301 in the network environment 1300 may communicate with an electronic device 1302 via a first network 1398 (e.g., a short-range wireless communication network), or at least one of an electronic device 1304 or a server 1308 via a second network 1399 (e.g., a long-range wireless communication network). According to an embodiment, the electronic device 1301 may communicate with the electronic device 1304 via the server 1308. According to an embodiment, the electronic device 1301 may include a processor 1320, memory 1330, an input module 1350, a sound output module 1355, a display module 1360, an audio module 1370, a sensor module 1376, an interface 1377, a connecting terminal 1378, a haptic module 1379, a camera module 1380, a power management module 1388, a battery 1389, a communication module 1390, a subscriber identification module (SIM) 1396, or an antenna module 1397. In some embodiments, at least one of the components (e.g., the connecting terminal 1378) may be omitted from the electronic device 1301, or one or more other components may be added in the electronic device 1301. In some embodiments, some of the components (e.g., the sensor module 1376, the camera module 1380, or the antenna module 1397) may be implemented as a single component (e.g., the display module 1360).

The processor 1320 may execute, for example, software (e.g., a program 1340) to control at least one other component (e.g., a hardware or software component) of the electronic device 1301 coupled with the processor 1320, and may perform various data processing or computation. According to an embodiment, as at least part of the data processing or computation, the processor 1320 may store a command or data received from another component (e.g., the sensor module 1376 or the communication module 1390) in volatile memory 1332, process the command or the data stored in the volatile memory 1332, and store resulting data in non-volatile memory 1334. According to an embodiment, the processor 1320 may include a main processor 1321 (e.g., a central processing unit (CPU) or an application processor (AP)), or an auxiliary processor 1323 (e.g., a graphics processing unit (GPU), a neural processing unit (NPU), an image signal processor (ISP), a sensor hub processor, or a communication processor (CP)) that is operable independently from, or in conjunction with, the main processor 1321. For example, when the electronic device 1301 includes the main processor 1321 and the auxiliary processor 1323, the auxiliary processor 1323 may be adapted to consume less power than the main processor 1321, or to be specific to a specified function. The auxiliary processor 1323 may be implemented as separate from, or as part of the main processor 1321.

The auxiliary processor 1323 may control at least some of functions or states related to at least one component (e.g., the display module 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). According to an embodiment, the auxiliary processor 1323 (e.g., an image signal processor or a communication processor) may be implemented as part of another component (e.g., the camera module 1380 or the communication module 1390) functionally related to the auxiliary processor 1323. According to an embodiment, the auxiliary processor 1323 (e.g., the neural processing unit) may include a hardware structure specified for artificial intelligence model processing. An artificial intelligence model may be generated by machine learning. Such learning may be performed, e.g., by the electronic device 1301 where the artificial intelligence is performed or via a separate server (e.g., the server 1308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1330 may store various data used by at least one component (e.g., the processor 1320 or the sensor module 1376) of the electronic device 1301. The various data may include, for example, software (e.g., the program 1340) and input data or output data for a command related thereto. The memory 1330 may include the volatile memory 1332 or the non-volatile memory 1334.

The program 1340 may be stored in the memory 1330 as software, and may include, for example, an operating system (OS) 1342, middleware 1344, or an application 1346.

The input module 1350 may receive a command or data to be used by another component (e.g., the processor 1320) of the electronic device 1301, from the outside (e.g., a user) of the electronic device 1301. The input module 1350 may include, for example, a microphone, a mouse, a keyboard, a key (e.g., a button), or a digital pen (e.g., a stylus pen).

The sound output module 1355 may output sound signals to the outside of the electronic device 1301. The sound output module 1355 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1360 may visually provide information to the outside (e.g., a user) of the electronic device 1301. The display module 1360 may include, for example, a display, a hologram device, or a projector and control circuitry to control a corresponding one of the display, hologram device, and projector. According to an embodiment, the display module 1360 may include a touch sensor adapted to detect a touch, or a pressure sensor adapted to measure the intensity of force incurred by the touch.

The audio module 1370 may convert a sound into an electrical signal and vice versa. According to an embodiment, the audio module 1370 may obtain the sound via the input module 1350, or output the sound via the sound output module 1355 or a headphone of an external electronic device (e.g., an electronic device 1302) directly (e.g., wiredly) or wirelessly coupled with the electronic device 1301.

The sensor module 1376 may detect an operational state (e.g., power or temperature) of the electronic device 1301 or an environmental state (e.g., a state of a user) external to the electronic device 1301, and then generate an electrical signal or data value corresponding to the detected state. According to an embodiment, the sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device (e.g., the electronic device 1302) directly (e.g., wiredly) or wirelessly. According to an embodiment, the interface 1377 may include, for example, a high definition multimedia interface (HDMI), a universal serial bus (USB) interface, a secure digital (SD) card interface, or an audio interface.

A connecting terminal 1378 may include a connector via which the electronic device 1301 may be physically connected with the external electronic device (e.g., the electronic device 1302). According to an embodiment, the connecting terminal 1378 may include, for example, an HDMI connector, a USB connector, an SD card connector, or an audio connector (e.g., a headphone connector).

The haptic module 1379 may convert an electrical signal into a mechanical stimulus (e.g., a vibration or a movement) or electrical stimulus which may be recognized by a user via his tactile sensation or kinesthetic sensation. According to an embodiment, the haptic module 1379 may include, for example, a motor, a piezoelectric element, or an electric stimulator.

The camera module 1380 may capture a still image or moving images. According to an embodiment, the camera module 1380 may include one or more lenses, image sensors, image signal processors, or flashes.

The power management module 1388 may manage power supplied to the electronic device 1301. According to an embodiment, the power management module 1388 may be implemented as at least part of, for example, a power management integrated circuit (PMIC).

The battery 1389 may supply power to at least one component of the electronic device 1301. According to an embodiment, the battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the application processor (AP)) and supports a direct (e.g., wired) communication or a wireless communication. According to an embodiment, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device via the first network 1398 (e.g., a short-range communication network, such as Bluetooth™, wireless-fidelity (Wi-Fi) direct, or infrared data association (IrDA)) or the second network 1399 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The wireless communication module 1392 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1392 may support a high-frequency band (e.g., the millimeter wave (mmWave) band) to achieve, e.g., a high data transmission rate. The wireless communication module 1392 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1392 may support various requirements specified in the electronic device 1301, an external electronic device (e.g., the electronic device 1304), or a network system (e.g., the second network 1399). According to an embodiment, the wireless communication module 1392 may support a peak data rate (e.g., 20 Gbps or more) for implementing eMBB, loss coverage (e.g., 1364 dB or less) for implementing mMTC, or user plane (U-plane) latency (e.g., 0.5 ms or less for each of downlink (DL) and uplink (UL), or a round trip of 13 ms or less) for implementing URLLC.

The antenna module 1397 may transmit or receive a signal or power to or from the outside (e.g., the external electronic device) of the electronic device 1301. According to an embodiment, the antenna module 1397 may include an antenna including a radiating element composed of a conductive material or a conductive pattern formed in or on a substrate (e.g., a printed circuit board (PCB)). According to an embodiment, the antenna module 1397 may include a plurality of antennas (e.g., array antennas). In such a case, at least one antenna appropriate for a communication scheme used in the communication network, such as the first network 1398 or the second network 1399, may be selected, for example, by the communication module 1390 (e.g., the wireless communication module 1392) from the plurality of antennas. The signal or the power may then be transmitted or received between the communication module 1390 and the external electronic device via the selected at least one antenna. According to an embodiment, another component (e.g., a radio frequency integrated circuit (RFIC)) other than the radiating element may be additionally formed as part of the antenna module 1397.

According to various embodiments, the antenna module 1397 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1301 and the external electronic device 1304 via the server 1308 coupled with the second network 1399. Each of the electronic devices 1302 or 1304 may be a device of a same type as, or a different type, from the electronic device 1301. According to an embodiment, all or some of operations to be executed at the electronic device 1301 may be executed at one or more of the external electronic devices 1302 or 1304, or the server 1308. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1301. The electronic device 1301 may provide the outcome, with or without further processing of the outcome, as at least part of a reply to the request. To that end, a cloud computing, distributed computing, mobile edge computing (MEC), or client-server computing technology may be used, for example. The electronic device 1301 may provide ultra low-latency services using, e.g., distributed computing or mobile edge computing. In another embodiment, the external electronic device 1304 may include an internet-of-things (IoT) device. The server 1308 may be an intelligent server using machine learning and/or a neural network. According to an embodiment, the external electronic device 1304 or the server 1308 may be included in the second network 1399. The electronic device 1301 may be applied to intelligent services (e.g., smart home, smart city, smart car, or healthcare) based on 5G communication technology or IoT-related technology.

As described above, an electronic device 100 may comprise a processor 401, a display 402 including display driver circuitry 403 and a display panel 110, and a proximity sensor 140 positioned under an active area 120 of the display panel 110. For example, the processor 401 may be configured to obtain, from the proximity sensor 140, data indicating whether an external object is adjacent to the display panel 110 while first light having a first wavelength is emitted from the proximity sensor 140. For example, the first light may be emitted in a state in which a black color is provided through a portion of the active area over the proximity sensor 140. For example, the first light may be emitted while displaying an image on the display panel 110 is deactivated. For example, the first light may be emitted while scanning of the display driver circuitry 403 is ceased. For example, the processor 401 may be configured to provide, to the display driver circuitry 403, an image to be displayed on the display panel 110, in response to the data obtained while the first light is emitted and indicating that an external object is not adjacent to the display panel 110. For example, the proximity sensor 140 may be configured to obtain, from the display driver circuitry 403, a synchronization signal provided from the display driver circuitry 403 to the processor 401 according to displaying of the image. For example, the proximity sensor 140 may be configured to emit second light having a second wavelength longer than the first wavelength to obtain the data within a time period in which the image is displayed on the display panel 110, in response to the synchronization signal.

For example, the proximity sensor 140 may be configured to cease emitting the first light in response to the synchronization signal.

For example, the processor 401 may be configured to maintain deactivation of providing the image to the display driver circuitry 403, based on the data obtained while the first light is emitted and indicating that an external object is adjacent to the display panel 110.

For example, the proximity sensor 140 may be configured to provide, to the processor 401, the data obtained while the second light is emitted. For example, the processor 401 may be configured to maintain activation of providing an image to the display driver circuitry 403 based on the synchronization signal, while identifying that the data obtained from the proximity sensor 140 while the second light is emitted indicates that an external object is not adjacent to the display panel 110. For example, the processor 401 may be configured to deactivate providing an image to the display driver circuitry 403 based on the synchronization signal, in response to identifying that the data obtained from the proximity sensor 140 while the second light is emitted indicates that an external object is adjacent to the display panel 110. For example, the display driver circuitry 403 may be configured to cease providing the synchronization signal to each of the processor 401 and the proximity sensor 140, based on the deactivation. For example, the proximity sensor 140 may be configured to emit the first light to obtain the data, based on the cessation of providing the synchronization signal.

For example, the proximity sensor 140 may be configured to cease emitting the second light, based on the cessation of providing the synchronization signal.

For example, the display panel 110 may include sub-pixels. For example, each of the sub-pixels may include a light-emitting element and a driving transistor configured to obtain a current provided to the light-emitting element. For example, the second light among the first light and the second light may be emitted from the proximity sensor 140 to reduce flickering occurring in the active area 120 according to shifting of a threshold voltage of the driving transistor.

For example, the second light may be emitted from the proximity sensor 140 by providing, to the proximity sensor 140, a second current higher than a first current provided to the proximity sensor 140 for emitting the first light.

For example, a duty ratio used for emitting the second light may be greater than a duty ratio used for emitting the first light.

For example, the image may be displayed on the display panel 110 for a call with a user of the external electronic device.

As described above, an electronic device may comprise a processor 401, a display 402 including display driver circuitry 403 and a display panel 110, and a proximity sensor 140 positioned under an active area 120 of the display panel 110. For example, the proximity sensor 140 may be configured to emit, while a black color is provided through a portion of the active area 120 over the proximity sensor 140, first light having a first wavelength to obtain data indicating whether an external object is adjacent to the display panel 110. For example, the first light may be emitted while displaying an image on the display panel 110 is deactivated. For example, the first light may be emitted while scanning of the display driver circuitry 403 is ceased. For example, the proximity sensor 140 may be configured to obtain, from the display driver circuitry 403, a synchronization signal provided from the display driver circuitry 403 to the processor 401 to indicate a timing for providing an image to the display driver circuitry 403, while the first light is emitted. For example, the proximity sensor 140 may be configured to emit second light having a second wavelength longer than the first wavelength to obtain the data, in response to the synchronization signal.

For example, the proximity sensor 140 may be configured to cease emitting the first light in response to the synchronization signal.

For example, the proximity sensor 140 may be configured to emit the first light based on obtaining, while the second light is emitted, the data indicating that an external object is adjacent to the display panel 110.

For example, the proximity sensor 140 may be configured to cease emitting the second light, based on obtaining, while the second light is emitted, the data indicating that an external object is adjacent to the display panel 110.

For example, the proximity sensor 140 may be configured to identify whether obtaining the synchronization signal from the display driver circuitry 403 while the second light is emitted is ceased for a reference time. For example, the proximity sensor 140 may be configured to cease emitting the second light for obtaining the data and emit the first light for obtaining the data, in response to identifying that obtaining the synchronization signal is ceased for the reference time. For example, the proximity sensor 140 may be configured to maintain emitting the second light for obtaining the data, while obtaining the synchronization signal is not ceased for the reference time.

For example, the electronic device 100 may include a path between the display driver circuitry 403 and the proximity sensor 140. The synchronization signal may be obtained from the display driver circuitry 403 through the path.

As described above, an electronic device may comprise a processor 401, a display 402 including display driver circuitry 403 and a display panel 110, and a proximity sensor 140 positioned under an active area 120 of the display panel 110. For example, the proximity sensor 140 may be configured to emit second light having a second wavelength to obtain data indicating whether an external object is adjacent to the display panel 110, based on obtaining, from the display driver circuitry 403, a synchronization signal provided from the display driver circuitry 403 to the processor 401 to indicate a timing of providing an image to the display driver circuitry 403. For example, the proximity sensor 140 may be configured to identify whether additionally obtaining the synchronization signal is ceased for a reference time. For example, the proximity sensor 140 may be configured to emit first light having a first wavelength shorter than the second wavelength to obtain the data, based on identifying that additionally obtaining the synchronization signal is ceased for the reference time.

For example, the proximity sensor 140 may be configured to maintain emitting the second light, based on identifying that additionally obtaining the synchronization signal is not ceased for the reference time.

For example, the proximity sensor 140 may be configured to cease emitting the second light, based on identifying that additionally obtaining the synchronization signal is ceased for the reference time.

For example, the proximity sensor 140 may be configured to emit the first light, based on identifying that the data obtained while the second light is emitted indicates that an external object is adjacent to the display panel 110.

For example, the proximity sensor 140 may be configured to cease emitting the second light, based on identifying that the data obtained while the second light is emitted indicates that an external object is adjacent to the display panel 110.

As described above, an electronic device 100 may comprise a processor 401, a display 402 including a display panel 110, and a proximity sensor 140 positioned under an active area 120 of the display panel 110. For example, the proximity sensor 140 may be configured to emit first light having a first wavelength to obtain data indicating whether an external object is adjacent to the display panel 110. For example, the proximity sensor 140 may be configured to obtain, from the processor 401, a signal indicating a start of displaying an image on the display panel 110 while the first light is emitted. For example, the proximity sensor 140 may be configured to cease emitting the first light for obtaining the data and to emit second light having a second wavelength longer than the first wavelength for obtaining the data, in response to the signal.

For example, the proximity sensor 140 may be configured to obtain, from the processor 401, another signal indicating a termination of displaying an image on the display panel 110 while the second light is emitted. For example, the proximity sensor 140 may be configured to cease emitting the second light for obtaining the data and to emit the first light for obtaining the data, in response to the another signal.

For example, emitting the second light may be maintained until the another signal is obtained.

For example, emitting the first light may be maintained until the signal is obtained.

For example, the signal may be provided to the proximity sensor 140 before a start of displaying an image on the display panel 110.

As described above, an electronic device 100 may comprise a display panel 110 and a proximity sensor 140 positioned under an active area 120 of the display panel 110, the proximity sensor 140 including first transmission circuitry configured to emit first light having a first wavelength, second transmission circuitry configured to emit second light having a second wavelength longer than the first wavelength, and at least one reception circuitry configured to receive reflection light of the first light or the second light. For example, the proximity sensor 140 may be configured to drive the first transmission circuitry among the first transmission circuitry and the second transmission circuitry to obtain data indicating whether an external object is adjacent to the electronic device 100, based on the reflection light, in accordance with a first state of the display panel 110. For example, the proximity sensor 140 may be configured to drive the second transmission circuitry among the first transmission circuitry and the second transmission circuitry to obtain the data based on the reflection light, in accordance with a second state of the display panel 110.

For example, a duty ratio used by the second transmission circuitry driven to periodically emit the second light may be greater than a duty ratio used by the first transmission circuitry driven to periodically emit the first light.

For example, an amplitude of current provided to the second transmission circuitry driven to emit the second light may be greater than an amplitude of current provided to the first transmission circuitry driven to emit the first light.

For example, the electronic device may further comprise a processor. For example, the processor 401 may be configured to identify a state of the display panel 110. For example, the processor 401 may be configured to control the proximity sensor 140 to drive the first transmission circuitry among the first transmission circuitry and the second transmission circuitry, based on identifying that the state is the first state. For example, the processor 401 may be configured to control the proximity sensor 140 to drive the second transmission circuitry among the first transmission circuitry and the second transmission circuitry, based on identifying that the state is the second state.

For example, the first state may be a state of providing a black color in a portion of the active area 120 over the proximity sensor 140, and the second state may be a state of providing another color distinguished from the black color in the portion.

For example, the processor 401 may be configured to identify whether the state is the first state or the second state, by obtaining an image to be displayed on the display panel 110 and identifying whether a partial area of the image corresponding to the portion has a black color.

For example, the processor 401 may be configured to identify a refresh rate for displaying on the display panel 110, identify the state as the first state based on the refresh rate lower than a reference refresh rate, and identify the state as the second state based on the refresh rate higher than or equal to the reference refresh rate. For example, the refresh rate lower than the reference refresh rate may be used in the electronic device 100 while providing an image for displaying on the display panel 110 by the processor 401 is deactivated to, and an image displayed based on the refresh rate lower than the reference refresh rate may have a black color in a partial area corresponding to the portion.

As described above, an electronic device may comprise a display and a proximity sensor for detecting an external object. The proximity sensor may include at least two light sources, positioned under an active area 120 of the display panel 110, having different wavelengths. The proximity sensor may include at least one light-receiving circuitry configured to receive reflection light of the wavelengths. The at least two light sources may be selectively driven in accordance with a state of the electronic device.

For example, from among the at least two light sources, a time duration for which a first light source of a first wavelength is driven may be shorter than a time duration for which a second light source of a second wavelength longer than the first wavelength.

For example, from among the at least two light sources, an amplitude of current input to a first light source while the first light source of a first wavelength is driven may be smaller than an amplitude of current input to a second light source while the second light source of a second wavelength longer than the first wavelength is driven.

For example, the electronic device may comprise at least one processor. The at least one processor may be configured to control the at least two light sources of the proximity sensor based on a state of the electronic device. The state of the electronic device may include a first state in which the display is activated and a second state in which the display is deactivated.

For example, the at least one processor may be configured to, in the second state, drive a first light source of a first wavelength from among the at least two light sources. The at least one processor may be configured to, in the first state, drive a second light source of a second wavelength longer than the first wavelength from among the at least two light sources.

For example, the second state may be a state providing black color in a portion of the active area being over the proximity sensor. The first state may be a state providing another color distinct from the black color of the portion of the active area.

For example, the at least one processor may be configured to obtain an image to be displayed on the display. The at least one processor may be configured to identify whether the state is the first state or the second state by identifying whether a partial area of the image corresponding to the portion of the active area has the black color.

For example, the at least two light sources may be selectively driven in accordance with a state of the electronic device defined by a synchronization signal provided from display driver circuitry of the display to the at least one processor according to displaying an image on the display.

For example, from among a first light source of a first wavelength and a second light source of a second wavelength longer than the first wavelength, the second light source may be driven for a time period in which the image is displayed on the display.

For example, the proximity sensor may be positioned under an active area of a display panel in the display.

For example, the electronic device may further comprise at least one processor comprising processing circuitry, and memory comprising one or more storage media storing instructions. The display may include display driver circuitry. The at least two light sources may include a first light source of a first wavelength and a second light source of a second wavelength. The instructions, when executed by the at least one processor individually or collectively, may cause the electronic device to, in response to a synchronization signal provided from the display driver circuitry to the at least one processor, control the proximity sensor to drive the second light source of the second wavelength.

For example, the instructions, when executed by the at least one processor individually or collectively, may cause the electronic device to, in response to a synchronization signal provided from the display driver circuitry to the at least one processor, control the proximity sensor to cease driving the first light source of the first wavelength.

For example, the instructions, when executed by the at least one processor individually or collectively, may cause the electronic device to, based on data, obtained from the proximity sensor while the first light source of the first wavelength is driven, indicating an external object being adjacent to the display, deactivate providing an image to the display.

For example, the instructions, when executed by the at least one processor individually or collectively, may cause the electronic device to, based on data, obtained from the proximity sensor while the second light source of the second wavelength is driven, indicating an external object being adjacent to the display, cease providing an image to the display in response to the synchronization signal.

For example, the instructions, when executed by the at least one processor individually or collectively, may cause the electronic device to, based on data, obtained from the proximity sensor while the second light source of the second wavelength is driven, indicating an external object being not adjacent to the display, maintain providing an image to the display in response to the synchronization signal.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1340) including one or more instructions that are stored in a storage medium (e.g., internal memory 1336 or external memory 1338) that is readable by a machine (e.g., the electronic device 1301). For example, a processor (e.g., the processor 1320) of the machine (e.g., the electronic device 1301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display; and
a proximity sensor for sensing an external object,
wherein the proximity sensor includes:
at least two light sources, positioned under an active area of the display, having different wavelengths, and
at least one light-receiving circuitry configured to receive reflection light of the wavelengths, and
wherein the at least two light sources are selectively driven in accordance with a state of the electronic device.

2. The electronic device of claim 1, wherein, from among the at least two light sources, a time duration for which a first light source of a first wavelength is driven is shorter than a time duration for which a second light source of a second wavelength longer than the first wavelength.

3. The electronic device of claim 1, wherein, from among the at least two light sources, an amplitude of current input to a first light source while the first light source of a first wavelength is driven is smaller than an amplitude of current input to a second light source while the second light source of a second wavelength longer than the first wavelength is driven.

4. The electronic device of claim 1, further comprising:
memory comprising one or more storage media storing instructions; and
at least one processor comprising processing circuitry communicatively coupled to the display, the proximity sensor and memory,
wherein the instructions, when executed by the at least one processor individually or collectively, cause the electronic device to control the at least two light sources of the proximity sensor based on a state of the electronic device, and
wherein the state of the electronic device comprises:
a first state in which the display is activated, and
a second state in which the display is deactivated.

5. The electronic device of claim 4, wherein the instructions, when executed by the at least one processor individually or collectively, further cause the electronic device to:
in the second state, drive a first light source of a first wavelength from among the at least two light sources, and
in the first state, drive a second light source of a second wavelength longer than the first wavelength from among the at least two light sources.

6. The electronic device of claim 4,
wherein the second state is a state providing black color in a portion of the active area being over the proximity sensor, and
wherein the first state is a state providing another color distinct from the black color of the portion of the active area.

7. The electronic device of claim 6, wherein the instructions, when executed by the at least one processor individually or collectively, further cause the electronic device to:
obtain an image to be displayed on the display, and
identify whether the state is the first state or the second state by identifying whether a partial area of the image corresponding to the portion of the active area has the black color.

8. The electronic device of claim 4, wherein the at least two light sources are selectively driven in accordance with a state of the electronic device defined by a synchronization signal provided from display driver circuitry of the display to the at least one processor according to displaying an image on the display.

9. The electronic device of claim 8, from among a first light source of a first wavelength and a second light source of a second wavelength longer than the first wavelength, the second light source is driven for a time period in which the image is displayed on the display.

10. The electronic device of claim 1, wherein the proximity sensor is positioned under an active area of a display panel in the display.

11. The electronic device of claim 1, further comprising:
memory comprising one or more storage media storing instructions; and
at least one processor comprising processing circuitry communicatively coupled to the display, the proximity sensor and memory,
wherein the display includes display driver circuitry,
wherein the at least two light sources include a first light source of a first wavelength and a second light source of a second wavelength, and
wherein the instructions, when executed by the at least one processor individually or collectively, cause the electronic device to, in response to a synchronization signal provided from the display driver circuitry to the at least one processor, control the proximity sensor to drive the second light source of the second wavelength.

12. The electronic device of claim 11, wherein the instructions, when executed by the at least one processor individually or collectively, further cause the electronic device to, in response to a synchronization signal provided from the display driver circuitry to the at least one processor, control the proximity sensor to cease driving the first light source of the first wavelength.

13. The electronic device of claim 11, wherein the instructions, when executed by the at least one processor individually or collectively, further cause the electronic device to, based on data, obtained from the proximity sensor while the first light source of the first wavelength is driven, indicating an external object being adjacent to the display, deactivate providing an image to the display.

14. The electronic device of claim 13, wherein the instructions, when executed by the at least one processor individually or collectively, further cause the electronic device to, based on data, obtained from the proximity sensor while the second light source of the second wavelength is driven, indicating an external object being adjacent to the display, cease providing an image to the display in response to the synchronization signal.

15. The electronic device of claim 13, wherein the instructions, when executed by the at least one processor individually or collectively, further cause the electronic device to, based on data, obtained from the proximity sensor while the second light source of the second wavelength is driven, indicating an external object being not adjacent to the display, maintain providing an image to the display in response to the synchronization signal.

16. An electronic device comprising:
at least one processor comprising processing circuitry;
a display including display driver circuitry and a display panel; and
a proximity sensor positioned under an active area of the display panel, wherein the proximity sensor is configured to:
while a black color is provided through a portion of the active area over the proximity sensor, emit first light having a first wavelength to obtain data indicating whether an external object is adjacent to the display panel,
wherein the first light is emitted while displaying an image on the display panel is deactivated, and is emitted while scanning of the display driver circuitry is ceased,
obtain, from the display driver circuitry, a synchronization signal provided from the display driver circuitry to the at least one processor to indicate a timing for providing an image to the display driver circuitry, while the first light is emitted, and
emit second light having a second wavelength longer than the first wavelength to obtain the data, in response to the synchronization signal.

17. The electronic device of claim 16, wherein the proximity sensor is configured to cease emitting the first light in response to the synchronization signal.

18. The electronic device of claim 17, wherein the proximity sensor is configured to emit the first light based on obtaining, while the second light is emitted, the data indicating that an external object is adjacent to the display panel.

19. The electronic device of claim 18, wherein the proximity sensor is configured to cease emitting the second light, based on obtaining, while the second light is emitted, the data indicating that an external object is adjacent to the display panel.

20. The electronic device of claim 19, wherein the proximity sensor is configured to:
identify whether obtaining the synchronization signal from the display driver circuitry while the second light is emitted is ceased for a reference time;
cease emitting the second light for obtaining the data and emit the first light for obtaining the data, in response to identifying that obtaining the synchronization signal is ceased for the reference time; and
maintain emitting the second light for obtaining the data, while obtaining the synchronization signal is not ceased for the reference time.
